(19) United States
(12) Patent Application Publication
(10) Pub. No.: US 2026/0255244 A1
(43) Pub. Date: Aug. 27, 2026

(54) METHOD AND APPARATUS OF SUPPORTING DELAY BUDGET HANDLING

(71) Applicant: Lenovo (Beijing) Limited, Beijing (CN)

(72) Inventors: Mingzeng Dai, Shanghai (CN); Jing Han, Beijing (CN); Xiaoying Xu, Shanghai (CN); Haiyan Luo, Shanghai (CN); Lianhai Wu, Beijing (CN)

(73) Assignee: Lenovo (Beijing) Limited, Beijing (CN)

(21) Appl. No.: 18/876,919

(22) PCT Filed: Jun. 24, 2022
(86) PCT No.: PCT/CN2022/101237

§ 371 Date: Dec. 19, 2024

(51) Int. Cl. H04W 36/24

(52) U.S. Cl. CPC H04W 36/249

(57) ABSTRACT

Embodiments of the present disclosure relate to methods and apparatuses of supporting delay budget handling. According to an embodiment of the present disclosure, an exemplary method may include: receiving information associated with an AN PSDB of a PDU set in response to a handover of a UE from a source RAN node to the RAN node; and performing data transmission of the PDU set at least based on the information associated with the AN PSDB.

### TECHNICAL FIELD

Embodiments of the present application generally relate to wireless communication technology, especially to a method and apparatus of supporting delay budget handling, e.g., supporting protocol data unit (PDU) set delay budget (PSDB) handling associated with handover.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) system (5GS) which may also be referred to as new radio (NR) systems.

On the other hand, extended reality (XR), including augmented reality (AR) and virtual reality (VR), as well as cloud gaming (CG), presents a new promising category of connected devices, applications, and services. Thus, 3rd generation partnership program (3GPP) has considered introducing XR into 3GPP, and the integration of XR applications within 5G system is approached following the model of 5G media streaming as defined in 3GPP. Accordingly, there are a mass of technical problems to be solved to support XR services (or applications, or traffics) in 5GS or in further LTE of radio access network (RAN). For example, one technical problem to be solved concerns XR management (XRM) services to improve quality of service (QoS) management and scheduling for XR, which is related to delay budget handling.

### SUMMARY OF THE APPLICATION

One objective of the embodiments of the present application is to provide a technical solution of supporting delay budget handling, e.g., a method and apparatus of supporting delay budget handling for XR services.

Some embodiments of the present application provide a RAN node, e.g., a target gNB, which includes: a transceiver; and a processor coupled to the transceiver, wherein the processor is configured to, cooperate with the transceiver, to: receive information associated with an access network (AN) PSDB (AN PSDB) of a PDU set in response to a handover of a user equipment (UE) from a source RAN node to the RAN node; and perform data transmission of the PDU set at least based on the information associated with the AN PSDB.

In some embodiments of the present application, the AN PSDB is a difference between time of a first PDU of a downlink PDU set arriving at a RAN node and time of a last PDU or all PDUs of the downlink PDU set being delivered to the UE successfully, or a difference between time of a first PDU of an uplink PDU set handling at the UE and time of a last PDU or all PDUs of the uplink PDU set being transmitted from the UE successfully.

According to some embodiments of the present application, the information associated with the AN PSDB indicates arrival time information on the first PDU of the PDU set and AN PSDB information indicating the AN PSDB, and the processor is configured to: calculate a remaining part of the AN PSDB based on the arrival time information on the first PDU of the PDU set and the AN PSDB information; and use the remaining part of the AN PSDB for data transmission of remaining PDUs of the PDU set. In an example, the information associated with the AN PSDB is received from the source RAN node, the PDU set is a downlink PDU set, and the arrival time information on the first PDU of the PDU set indicates at least one of the following:
absolute time of the first PDU of the PDU set arriving at the source RAN node from a core network (CN) node;
system frame number (SFN) timing that represents time of the first PDU of the PDU set arriving at the source RAN node from the CN node; or
buffered time of the first PDU of the PDU set at the source RAN node.

According to some embodiments of the present application, the information associated with the AN PSDB is received from the source RAN node or the UE, the PDU set is an uplink PDU set, and the arrival time information on the first PDU of the PDU set indicates at least one of the following:
absolute time of receiving buffer status reporting (BSR) for transmission of the first PDU of the PDU set from the UE;
absolute time of the first PDU arriving at an access stratum (AS) layer reported by the UE;
absolute time of the first PDU generated in an application layer reported by the UE;
SFN timing that represents time of receiving BSR for transmission of the first PDU of the PDU set from the UE;
SFN timing that represents time of the first PDU arriving at an AS layer reported by the UE;
SFN timing that represents the first PDU generated in an application layer reported by the UE; or
buffered time of the first uplink PDU of the PDU set at the UE.

In some embodiments of the present application, the AN PSDB is a difference between time of a last PDU of a downlink PDU set arriving at a RAN node and time of the last PDU or all PDUs of the downlink PDU set being delivered to the UE successfully, or a difference between time of a last PDU of an uplink PDU set handling at the UE and time of the last PDU or all PDUs of the uplink PDU set being transmitted from the UE successfully.

According to some embodiments of the present application, the information associated with the AN PSDB indicates arrival time information on the last PDU of the PDU set and AN PSDB information indicating the AN PSDB, and the processor is configured to: calculate a remaining part of the AN PSDB based on the arrival time information on the last PDU of the PDU set and the AN PSDB information, and use the remaining part of the AN PSDB for data transmission of remaining PDUs of the PDU set.

In an example, the information associated with the AN PSDB is received from the source RAN node, the PDU set is a downlink PDU set, and the arrival time information on the last PDU of the PDU set indicates at least one of the following:
absolute time of the last PDU of the PDU set arriving at the source RAN node from a CN node;
SFN timing that represents time of the last PDU of the PDU set arriving at the source RAN node from the CN node; or
buffered time of the last PDU of the PDU set at the source RAN node.

In another example, the information associated with the AN PSDB is received from the UE, the PDU set is an uplink PDU set, and the arrival time information on the last PDU of the PDU set indicates at least one of the following:
absolute time of receiving BSR for transmission of the last PDU of the PDU set from the UE;
absolute time of the last PDU arriving at an AS layer reported by the UE; absolute time of the last PDU generated in an application layer reported by the UE;
SFN timing that represents time of receiving BSR for transmission of the last PDU of the PDU set from the UE;
SFN timing that represents time of the last PDU arriving at an AS reported by the UE;
SFN timing that represents the last PDU generated in an application layer reported by the UE; or
buffered time of the last PDU of the PDU set at the UE.

In some embodiments of the present application, the information associated with the AN PSDB indicates AN PSDB information indicating the AN PSDB and a passed part of the AN PSDB, and the processor is configured to: calculate a remaining part of the AN PSDB based on the AN PSDB information and the passed part of the AN PSDB, and use the remaining part of the AN PSDB for data transmission of the remaining PDUs of the PDU set.

In some embodiments of the present application, the information associated with the AN PSDB indicates a remaining part of the AN PSDB of the PDU set, and the processor is configured to use the remaining part of the AN PSDB for data transmission of remaining PDUs of the PDU set.

In some embodiments of the present application, the information associated with the AN PSDB is received from the source RAN node during the handover via at least one of the following:
a signaling of handover request;
a signaling of sequence number (SN) status transfer;
a user plane protocol carried by general packet radio service (GPRS) tunnel protocol for the user plane (GTP-U) extension header; or
a source to target transparent container within handover related signaling.

In some embodiments of the present application, the information associated with the AN PSDB is received from the UE in response to success of the handover via a packet data convergence protocol (PDCP) header, or media access control (MAC) control element (CE) or PDCP control PDU, or radio resource control (RRC) signaling.

In some embodiments of the present application, the AN PSDB information indirectly indicates the AN PSDB by including a total PSDB and CN PSDB, or directly indicates the AN PSDB.

Some embodiments of the present application provide a wireless communication apparatus, e.g., a source gNB or a UE, which includes: a transceiver; and a processor coupled to the transceiver, wherein the processor is configured to, cooperate with the transceiver, to: receive first information indicating AN PSDB of a PDU set; and transmit second information associated with the AN PSDB of the PDU set at least based on the first information indicating the AN PSDB in response to a handover of a UE that happens during data transmission of the PDU set.

In some embodiments of the present application, the AN PSDB is a difference between time of a first PDU of a downlink PDU set arriving at a RAN node and time of a last PDU or all PDUs of the downlink PDU set being delivered to the UE successfully, or a difference between time of a first PDU of a uplink PDU set handling at the UE and time of a last PDU or all PDUs of the uplink PDU set being transmitted from the UE successfully.

According to some embodiments of the present application, the second information associated with the AN PSDB indicates arrival time information on the first PDU of the PDU set and third information indicating the AN PSDB.

In some embodiments of the present application, the second information associated with the AN PSDB indicates third information indicating the AN PSDB and a passed part of the AN PSDB, and the processor is configured to: calculate the passed part of the AN PSDB based on arrival time information on the first PDU of the PDU set.

In some embodiments of the present application, the second information associated with the AN PSDB indicates a remaining part of the AN PSDB of the PDU set, and the processor is configured to:
calculate a passed part of the AN PSDB based on arrival time information on the first PDU of the PDU set; and
calculate the remaining part of the AN PSDB based on the passed part of the AN PSDB and the first information indicating the AN PSDB.

According to some embodiments of the present application, the second information associated with the AN PSDB indicates arrival time information on the last PDU of the PDU set or a passed part of the AN PSDB, wherein the passed part of the AN PSDB is calculated based on the arrival time information on the last PDU of the PDU set.

According to some embodiments of the present application, an exemplary wireless communication apparatus is a source RAN node of the UE, the PDU set is a downlink PDU set, and the arrival time information on the first PDU of the PDU set indicates at least one of the following:
absolute time of the first PDU of the PDU set arriving at the source RAN node from a CN node;
SFN timing that represents time of the first PDU of the PDU set arriving at the source RAN node from the CN node; or
buffered time of the first PDU of the PDU set at the source RAN node.

According to some embodiments of the present application, an exemplary wireless communication apparatus is a source RAN node of the UE or the UE, the PDU set is an uplink PDU set, and the arrival time information on the first PDU of the PDU set indicates at least one of the following:
absolute time of receiving BSR for transmission of the first PDU of the PDU set from the UE;
absolute time of the first PDU arriving at an AS layer reported by the UE; absolute time of the first PDU generated in an application layer reported by the UE;
SFN timing that represents time of receiving BSR for transmission of the first PDU of the PDU set from the UE;
SFN timing that represents time of the first PDU arriving at an AS layer reported by the UE;
SFN timing that represents the first PDU generated in an application layer reported by the UE; or
buffered time of the first uplink PDU of the PDU set at the UE.

According to some embodiments of the present application, in the case that the wireless communication apparatus is a source RAN node in a center unit (CU)-distributed unit (DU) split architecture and a DU of the source RAN node receives the arrival time information on the first PDU of the PDU set, a CU of the source RAN node receives the arrival time information on the first PDU of the PDU set from the DU via F1-AP signaling or F1-U user plane protocol.

According to some embodiments of the present application, the wireless communication apparatus is a source RAN node of the UE, the PDU set is a downlink PDU set, and in the case that a first PDU of the PDU set arrives at the source RAN node during execution of the handover or after the handover is completed, the second information associated with the AN PSDB indicates that entire of the AN PSDB is to be used for data transmission of the PDU set or buffered time of the first PDU of the PDU set at the source RAN node is zero.

According to some embodiments of the present application, the wireless communication apparatus is the UE, the PDU set is an uplink PDU set, and in the case that a first PDU of the PDU set arrives at the UE later than receiving handover command, or during execution of the handover or after the handover is completed, the second information associated with the AN PSDB indicates that entire of the AN PSDB is to be used for data transmission of the PDU set or the buffered time of the first PDU of the PDU set at the UE is zero.

In some embodiments of the present application, the AN PSDB is a difference between time of a last PDU of a downlink PDU set arriving at a RAN node and time of the last PDU or all PDUs of the downlink PDU set being delivered to the UE successfully, or a difference between time of a last PDU of an uplink PDU set handling at the UE and time of the last PDU or all PDUs of the uplink PDU set being transmitted from the UE successfully.

According to some embodiments of the present application, the second information associated with the AN PSDB indicates arrival time information on the last PDU of the PDU set and third information indicating the AN PSDB.

According to some embodiments of the present application, the second information associated with the AN PSDB indicates third information indicating the AN PSDB and a passed part of the AN PSDB, and the processor is configured to: calculate the passed part of the AN PSDB based on arrival time information on the last PDU of the PDU set.

According to some embodiments of the present application, the second information associated with the AN PSDB indicates a remaining part of the AN PSDB of the PDU set, and the processor is configured to: calculate a passed part of the AN PSDB based on arrival time information on the last PDU of the PDU set; and calculate the remaining passed part of the AN PSDB based on the passed part of the AN PSDB and the first information indicating the AN PSDB.

According to some embodiments of the present application, the second information associated with the AN PSDB indicates arrival time information on the last PDU of the PDU set or a passed part of the AN PSDB, wherein the passed part of the AN PSDB is calculated based on the arrival time information on the last PDU of the PDU set.

According to some embodiments of the present application, the wireless communication apparatus is a source RAN node of the UE, the PDU set is a downlink PDU set, and the arrival time information on the last PDU of the PDU set indicates at least one of the following:
absolute time of the last PDU of the PDU set arriving at the source RAN node from a CN node;
SFN timing that represents time of the last PDU of the PDU set arriving at the source RAN node from the CN node; or
buffered time of the last PDU of the PDU set at the source RAN node.

According to some embodiments of the present application, the wireless communication apparatus is the UE, the PDU set is an uplink PDU set, and the arrival time information on the last PDU of the PDU set indicates at least one of the following:
absolute time of receiving BSR for transmission of the last PDU of the PDU set from the UE;
absolute time of the last PDU arriving at an AS layer reported by the UE; absolute time of the last PDU generated in an application layer reported by the UE;
SFN timing that represents time of receiving BSR for transmission of the last PDU of the PDU set from the UE;
SFN timing that represents time of the last PDU arriving at an AS reported by the UE;
SFN timing that represents the last PDU generated in an application layer reported by the UE; or
buffered time of the last PDU of the PDU set at the UE.

According to some embodiments of the present application, the wireless communication apparatus is a source RAN node of the UE, the PDU set is a downlink PDU set, and in the case that a last PDU of the PDU set arrives at the source RAN node during execution of the handover or after the handover is completed, the second information associated with the AN PSDB indicates that entire of the AN PSDB is to be used for data transmission of the PDU set or buffered time of the last PDU of the PDU set at the source RAN node is zero.

According to some embodiments of the present application, the wireless communication apparatus is the UE, the PDU set is an uplink PDU set, and in the case that a last PDU of the PDU set arrives at the UE later than receiving handover command, or during execution of the handover or after the handover is completed, the second information associated with the AN PSDB indicates that entire of the AN PSDB is to be used for data transmission of the PDU set or the buffered time of the last PDU of the PDU set at the UE is zero.

In some embodiments of the present application, the wireless communication apparatus is a source RAN node of the UE, and the second information associated with the AN PSDB is transmitted during the handover via at least one of the following:
a signaling of handover request;
a signaling of SN status transfer;
a user plane protocol carried by general packet radio service (GPRS) tunnel protocol for the user plane (GTP-U) extension header; or
a source to target transparent container within handover related signaling.

In some embodiments of the present application, the wireless communication apparatus is the UE, and the second information associated with the AN PSDB is transmitted from the UE in response to success of the handover via a PDCP header, or MAC CE or PDCP control PDU, or RRC signaling.

In some embodiments of the present application, the first information indicating the AN PSDB indirectly indicates the AN PSDB by including a total PSDB and a CN PSDB, or directly indicates the AN PSDB.

In some embodiments of the present application, the third information indicating the AN PSDB indirectly indicates the AN PSDB by including a total PSDB and a CN PSDB, or directly indicates the AN PSDB.

Some embodiments of the present application also provide a method, e.g., a method performed by a target gNB, which includes: receiving information associated with an AN PSDB of a PDU set in response to a handover of a UE from a source RAN node to the RAN node; and performing data transmission of the PDU set at least based on the information associated with the AN PSDB.

Some embodiments of the present application also provide another method, e.g., a method performed by a source gNB or a UE, which includes: receiving first information indicating an AN PSDB of a PDU set; and transmitting second information associated with the AN PSDB of the PDU set at least based on the first information indicating the AN PSDB in response to a handover of a UE that happens during data transmission of the PDU set.

Given the above, embodiments of the present application provide a technical solution of supporting delay budget handling, e.g., a method and apparatus of supporting delay budget handling, which can be used for XRM services. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a schematic diagram illustrating an internal structure of a RAN node according to some embodiments of the present application.

FIG. 3 is a schematic diagram illustrating an exemplary AN PSDB of a PDU set according to some embodiments of the present application.

FIG. 4 is a flow chart illustrating a method of supporting delay budget handling according to some embodiments of the present application.

FIG. 5 is a flow chart illustrating an exemplary procedure of a method supporting delay budget handling according to some embodiments of the present applications.

FIG. 6 is a flow chart illustrating an exemplary procedure of a method supporting delay budget handling according to some other embodiments of the present applications.

FIG. 7 illustrates a block diagram of an apparatus of supporting delay budget handling according to some embodiments of the present application.

FIG. 8 illustrates a block diagram of an apparatus of supporting delay budget handling according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

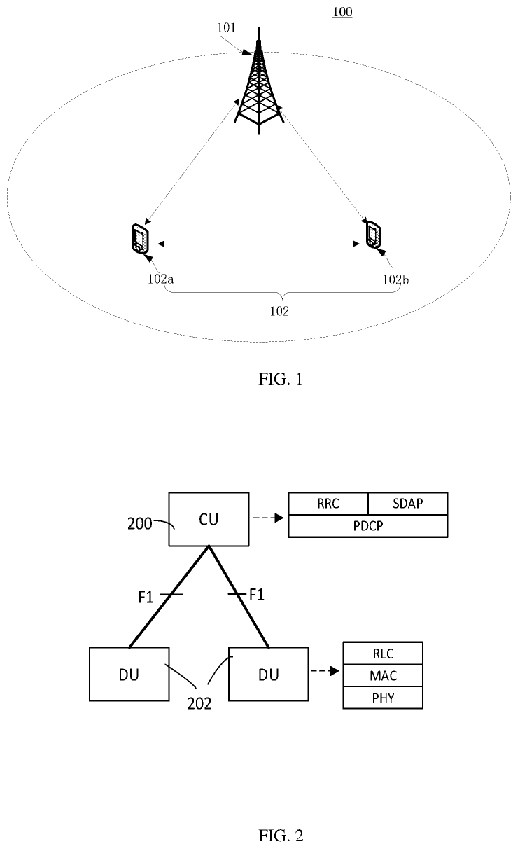

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two terminal device 102 (e.g., a first UE 102a and a second UE 102b) for illustrative purpose. Although a specific number of BSs and terminal devices are illustrated in FIG. 1 for simplicity, it is contemplated that the wireless communication system 100 may include more or less BSs and terminal devices in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), an authentication and mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node. Each BS may serve a number of UE(s) within a serving area, for example, a cell or a cell sector via a wireless communication link. Neighbor BSs may communicate with each other as necessary, e.g., during a handover procedure for a UE.

The terminal device (or remote apparatus) 102, e.g., the first UE 102a and the second UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the terminal device may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the terminal device may include wearable devices, such as smart watches, fitness bands, optical head-mounted displays, or the like. Moreover, the terminal device may be referred to as a subscriber unit, a mobile, a mobile station, a user, a terminal, a mobile terminal, a wireless terminal, a fixed terminal, a subscriber station, a user terminal, or a device, or described using other terminology used in the art. Herein (through the specification), although “UE” is used exemplarily as a classical terminal device for illustrating the terminal device, it should be understood as any type terminal device.

FIG. 2 is a schematic diagram illustrating an internal structure of a RAN node, e.g., a BS according to some embodiments of the present application.

Referring to FIG. 2, in a CU-DU split based RAN architecture, the internal structure of a RAN node (e.g., BS 101) may be split into a CU 200 and at least one DU 202 (e.g., two DUs shown in FIG. 2). Although a specific number of DUs 202 are depicted in FIG. 2, it is contemplated that any number of DUs 202 may be included in the BS.

The CU 200 and DU 202 are connected with each other by an interface called F1 as specified in 3GPP standard documents. The RRC layer functionality, service data adaptation protocol (SDAP) functionality, and the PDCP layer functionality are located in the CU 200. The radio link control (RLC) layer functionality, MAC layer functionality, and the physical (PHY) layer functionality are located in the DU 202.

When integrating XR applications into 5GS, a PDU set and PDU set QoS characteristics may be introduced as discussed in TR 23.700-60. A PDU set is composed of one or more PDUs carrying the payload of one unit of information generated at the application level (e.g. a frame or video slice for XRM services, as used in TR 26.926). In some implementations, all PDUs in a PDU set are needed by the application layer to use the corresponding unit of information. In some other implementations, when some PDUs are missing, the application layer can still recover part(s) or all of the information unit. PSDB is a PDU set level QoS parameter, which defines an upper bound for the time that a PDU set may be delayed between the UE and a N6 termination point at the UPF. An AN PSDB may be determined by subtracting a static value for the CN PSDB from a given PSDB (also referred to as a total PSDB). A CN PSDB represents the delay between any N6 termination point at the UPF (for any UPF that may possibly be selected for the PDU session) and the AN. The given PSDB can be configured by the CN side.

The AN PSDB can be interpreted in various manners. For example, some embodiments of the present application provide two definition of AN PSDB of PDU set, e.g., Definition 1 and Definition 2. According to Definition 1, for a downlink PDU set, an AN PSDB (also referred to as DL AN PSDB) is a difference between time of a first PDU of the downlink PDU set arriving at a RAN node and time of a last PDU or all PDUs of the downlink PDU set being delivered to a UE successfully; and for an uplink PDU set, an AN PSDB (also referred to as UL AN PSDB) is a difference between time of a first PDU of an uplink PDU set handling at a UE and time of a last PDU or all PDUs of the uplink PDU set being transmitted from the UE successfully. The time of a first PDU of an uplink PDU set handling at UE may represent the first PDU of an uplink PDU set is generated in the UE application layer, or the first PDU of an uplink PDU set is arriving at UE AS layer, or the UE triggers the BSR procedure for transmitting the first PDU of an uplink PDU set. According to Definition 2, for a downlink PDU set, an AN PSDB is a difference between time of a last PDU of a downlink PDU set arriving at a RAN node and time of the last PDU or all PDUs of the downlink PDU set being delivered to a UE successfully; and for an uplink PDU set, an AN PSDB is a difference between time of a last PDU of an uplink PDU set handling at the UE and time of the last PDU or all PDUs of the uplink PDU set being transmitted from the UE successfully. The time of a last PDU of an uplink PDU set handling at UE may represent the last PDU of an uplink PDU set is generated in the UE application layer, or the last PDU of an uplink PDU set is arriving at UE AS layer, or the UE triggers the BSR procedure for transmitting the last PDU of an uplink PDU set. In addition, under any definition of AN PSDB, the same AN PSDB can be jointly used for both data transmission of the downlink PDU set(s) and uplink PDU set(s) or can be separately used for only one of data transmission of the downlink PDU set(s) and uplink PDU set(s). For example, for a DL AN PSDB, it can only be configured for downlink PDU set(s) in some scenarios, while it can also be configured for the data transmission of uplink PDU set(s) besides that of downlink PDU set(s). Similarly, a UL AN PSDB can only be configured for uplink PDU set(s) in some scenarios, while it can also be configured for the data transmission of downlink PDU set(s) besides that of uplink PDU set(s).

However, a handover may happen during the data transmission of a PDU set. FIG. 3 is a schematic diagram illustrating an exemplary AN PSDB of a PDU set according to some embodiments of the present application, wherein a handover happens during the data transmission of the PDU set.

Referring to FIG. 3, taking a downlink PDU set and Definition 1 as an example, the AN PSDB is the difference between the time when the first PDU of the downlink PDU set arrives at the gNB, e.g., to and the time when the last PDU or all PDUs of the PDU set have been delivered to the UE successfully, e.g., t3. It is supposed that a PDU set including 8 PDUs will be transmitted to the UE according to the AN PSDB, wherein the first PDU is transmitted to the UE at time t1. However, a handover may happen during the transmission of the PDU set, e.g., at t2. Thus, it is possible that partial PDUs of the PDU set, e.g., PDUs 1, 2 and 3 have been successfully transmitted by the source gNB, while the other PDUs, e.g., PDUs 4 to 8 of the PDU set need to be transmitted by the target gNB. In this case, the target gNB should be aware of the remaining AN PSDB for transmitting the remaining PDUs of the PDU set to pursue more accurate QoS management and scheduling. The remaining AN PSDB (i.e., the remaining part of the AN PSDB) can be determined by subtracting a passed AN PSDB (i.e., the passed part of the AN PSDB) from a given or total AN PSDB. Similar issues will also occur when the AN PSDB is interpreted in other manners. For example, considering Definition 2, t0 may refer to the time that the last PDU of a downlink PDU set arrives at a RAN node or a last PDU of an uplink PDU set handling at the UE, while descriptions of t1, t2 and t3 will not change.

At least considering the above issues, embodiments of the present application propose a technical solution of supporting delay budget handling, e.g., for XRM services. For example, a wireless communication apparatus other than the target RAN node, e.g., a source gNB or a UE or the like will directly indicate the remaining AN PSDB to the target gNB. In another example, a wireless communication apparatus other than the target RAN node, e.g., a source gNB or a UE or the like will indirectly indicate the remaining AN PSDB to the target gNB by indicating related information, and the target gNB can determine the remaining AN PSDB based on the related information.

In addition, although the concepts related to PSDB (including the given PSDB, AN PSDB, CN PSDB etc.) are proposed based on PDU set, which is proposed for XR services or XR applications, they may change as the evolution of 3GPP specification, and thus should be used to unduly limit to the above illustrated examples.

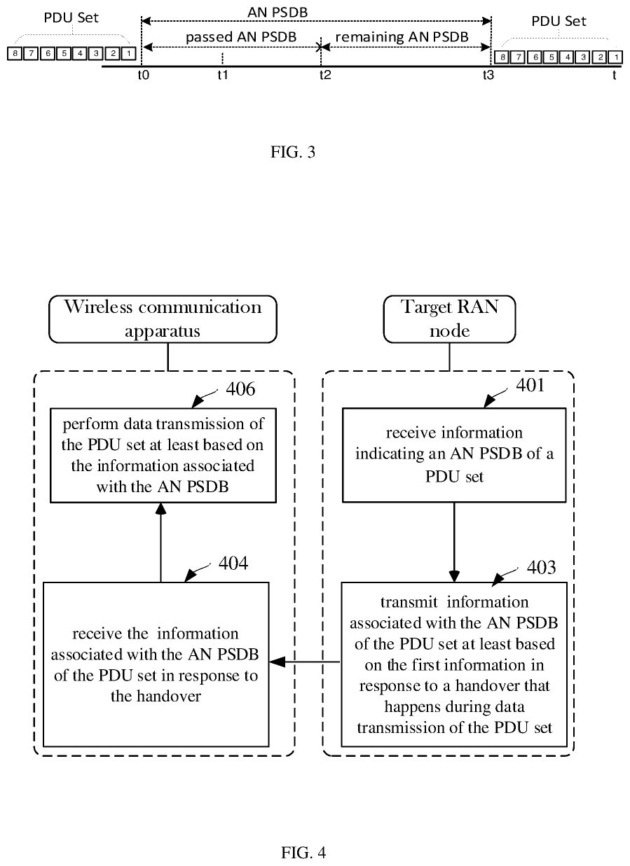

FIG. 4 is a flow chart illustrating a method of supporting delay budget handling according to some embodiments of the present application, wherein a handover of a UE from a source RAN node to a target RAN node is considered. Although the method is illustrated in a system level between a wireless communication apparatus (e.g., a source RAN node or a remote apparatus) and a target RAN node, e.g., a target gNB; persons skilled in the art should understand that the method implemented in the wireless communication apparatus and the target RAN node can be separately implemented and/or incorporated by other apparatus with the like functions.

Referring to FIG. 4, the wireless communication apparatus will receive information indicating an AN PSDB of a PDU set (hereafter, the first information) in step 401. For example, in the case that the wireless communication apparatus is a source RAN node, e.g., a source gNB, the source RAN node may receive the first information from the CN side, e.g., the AMF. In the case that the wireless communication apparatus is a remote apparatus, e.g., a UE, the UE may receive the first information from a source RAN node or the CN side e.g., the AMF. The first information may directly indicate the AN PSDB of the PDU set, or indirectly indicate the AN PSDB of the PDU set by including a total PSDB and a CN PSDB. The PDU set may be a downlink PDU set from the CN side, e.g., the UPF to the UE via a gNB or an uplink PDU set from the UE to the UPF via a gNB.

Due to the mobility of the UE, a handover to a target RAN node may happen during the data transmission of the PDU set. Herein, data transmission of the PDU set covers the transmission of downlink PDU set to the UE and/or the reception or scheduling of uplink PDU set from the UE, which should be well understood by persons skilled in the art. In addition, the duration of the data transmission of a PDU set should be understood in the most broad scope, which should include any PDU set that needs the source RAN node transfer one or more PDUs to the target RAN node even if the first PDU of the PDU set arrives at the source RAN node or the first PDU of the PDU set handles at UE after the handover is completed.

In response to the handover of the UE, the wireless communication apparatus will determine information associated with the AN PSDB of the PDU set (hereafter the second information) based on the first information. The wireless communication apparatus will transmit the second information to the target RAN node in step 403, so that the target RAN node can perform the QoS management and scheduling on the PDU set. For example, in the case that the wireless communication apparatus is a source RAN node, the source RAN node may transmit the second information during the handover via at least one of the following: a signaling of handover request, a signaling of SN status transfer, a user plane protocol carried by GTP-U extension header or a source to target transparent container within handover related signaling. In the case that the wireless communication apparatus is a UE, the UE may transmit the second information in response to the success of the handover, e.g., via a PDCP header, or MAC CE or PDCP control PDU, or RRC signaling.

In step 404, the target RAN node will receive the second information accordingly. The second information may directly or indirectly indicate the remaining AN PSDB. For example, under Definition 1, the second information may indicate arrival time information on the first PDU of the PDU set and AN PSDB information indicating the AN PSDB (hereafter, the third information). Similar to the first information, the third information may directly indicate the AN PSDB or indirectly indicate the AN PSDB by including the total PSDB and the CN PSDB. The first information and the third information can indicate the AN PSDB in the same or different manners, and the AN PSDB determined based on the third information is the same as that determined based on the first information. The target RAN node will calculate the remaining AN PSDB based on the arrival time information on the first PDU of the PDU set and the AN PSDB calculated or determined from the third information. For example, the target RAN node may first calculate the passed AN PSDB based on the arrival time information on the first PDU of the PDU set, and then calculate the remaining AN PSDB based on the passed AN PSDB and the AN PSDB, e.g., by subtracting the passed AN PSDB from the AN PSDB.

There are also several manners for calculating the passed AN PSDB by the target RAN node. In view of the exemplary definitions of AN PSDB, the passed AN PSDB can be calculated by the target RAN node based on the arrival time information on the first PDU of the PDU set under Definition 1, or based on the arrival time information on the last PDU of the PDU set under Definition 2.

For example, under Definition 1, an exemplary passed AN PSDB calculated by the target RAN node for a downlink PDU set (also referred to as passed DL AN PSDB) is the difference between the time of the first forwarding PDU of the PDU set arrived at the target RAN node and the arrival time information of the first PDU of the PDU set, that is, the passed DL AN PSDB is the time of the first forwarding PDU of the PDU set arrived at the target RAN node minus the arrival time information of the first PDU. Another exemplary passed DL AN PSDB is the difference between the time of a handover request message or SN status transfer message or the like arrived at the target RAN node and the arrival time information of the first PDU of the PDU set, that is, the passed DL AN PSDB is the time of the handover request message or SN status transfer message or the like arrived at the target RAN node minus the arrival time information of the first PDU. The target RAN node can calculate the passed AN PSDB for an uplink PDU set (hereafter, UL passed AN PSDB) in similar manners to the passed DL AN PSDB.

Similarly, under Definition 2, the second information may indicate arrival time information on the last PDU of the PDU set and the third information, i.e., the AN PSDB information indicating the AN PSDB. The target RAN node will calculate the remaining AN PSDB based on the arrival time information on the last PDU of the PDU set and the AN PSDB calculated or determined from the AN PSDB information. For example, the target RAN node may first calculate the passed AN PSDB based on the arrival time information on the last PDU of the PDU set, and then calculate the remaining AN PSDB based on the passed AN PSDB and the AN PSDB, e.g., by subtracting the passed AN PSDB from the AN PSDB.

Similarly, under definition 2, a passed DL AN PSDB can be calculated by the target RAN node in various manners. For example, an exemplary passed AN PSDB calculated by the target RAN node for a downlink PDU set (also referred to as passed DL AN PSDB) is the difference between the time of the first forwarding PDU of the PDU set arrived at the target RAN node and the arrival time information of the last PDU of the PDU set, that is, the passed DL AN PSDB is the time of the first forwarding PDU of the PDU set arrived at the target RAN node minus the arrival time information of the last PDU. Another exemplary passed DL AN PSDB calculated by the target RAN node is the difference between the time of a handover request message or SN status transfer message or the like arrived at the target RAN node and the arrival time information of the last PDU of the PDU set, that is, the passed DL AN PSDB is the time of the handover request message or SN status transfer message or the like arrived at the target RAN node minus the arrival time information of the last PDU. In addition, the target RAN node can calculate the passed AN PSDB for an uplink PDU set in similar manners to the passed DL AN PSDB under Definition 2.

In another example, the second information may indicate the third information and the passed AN PSDB. The passed AN PSDB can be calculated similar to the target RAN node as illustrated above. In view of the exemplary definitions of AN PSDB, the passed AN PSDB can be calculated by the wireless communication apparatus based on the arrival time information on the first PDU of the PDU set under Definition 1, or based on the arrival time information on the last PDU of the PDU set under Definition 2.

For example, under Definition 1, a passed DL AN PSDB calculated by a source RAN node is the difference between the time of the first forwarding PDU of the PDU set sent by the source RAN node and the arrival time information of the first PDU, that is, an exemplary passed DL AN PSDB calculated by the source RAN node is the time of the first forwarding PDU of the PDU set sent by the source RAN node minus the arrival time information of the first PDU. Another exemplary passed DL AN PSDB calculated by the source RAN node is the difference between the time of the handover request message or SN status transfer message or the like sent by the source RAN node and the arrival time information of the first PDU, that is, another exemplary passed DL AN PSDB calculated by the source RAN node is the time of the handover request message or SN status transfer message or the like sent by the source RAN node minus the arrival time information of the first PDU. The source RAN node can calculate the passed AN PSDB for an uplink PDU set in similar manners to the passed DL AN PSDB.

Similarly, under Definition 2, a passed DL AN PSDB calculated by a source RAN node is the difference between the time of the first forwarding PDU of the PDU set sent by the source RAN node and the arrival time information of the last PDU, that is, an exemplary passed DL AN PSDB calculated by the source RAN node is the time of the first forwarding PDU of the PDU set sent by the source RAN node minus the arrival time information of the last PDU. Another exemplary passed DL AN PSDB calculated by the source RAN node is the difference between the time of the handover request message or SN status transfer message or the like sent by the source RAN node and the arrival time information of the last PDU, that is, another exemplary passed DL AN PSDB calculated by the source RAN node is the time of the handover request message or SN status transfer message or the like sent by the source RAN node minus the arrival time information of the last PDU. The source RAN node can calculate the passed AN PSDB for an uplink PDU set in similar manners to the passed DL AN PSDB.

In the case that the wireless communication apparatus is a UE, UL passed AN PSDB can be calculated by the UE. For example, under Definition 1, an exemplary passed AN PSDB calculated by the UE for an uplink PDU set is the difference between the time of receiving the handover command and the arrival time information of the first PDU of the PDU set, that is, the passed UL AN PSDB is the time of receiving the handover command minus the arrival time information of the first PDU. Another exemplary passed UL AN PSDB calculated by the UE is the difference between the time that the handover is completed and the arrival time information of the first PDU of the PDU set, that is, the passed UL AN PSDB is the time that the handover is completed minus the arrival time information of the first PDU. Yet another exemplary passed UL AN PSDB calculated by the UE is the difference between the time that the passed AN PSDB is to be transmitted and the arrival time information of the first PDU of the PDU set, that is, the passed UL AN PSDB is the time that the passed AN PSDB is to be transmitted minus the arrival time information of the first PDU. Under definition 2, a passed UL AN PSDB can be calculated by the UE in similar manners.

Then, the target RAN node will calculate the remaining AN PSDB based on the AN PSDB determined from the third information and the passed AN PSDB, e.g., by subtracting the passed AN PSDB from the AN PSDB.

In yet another example, the wireless communication apparatus may calculate the remaining AN PSDB by itself. Accordingly, the second information may directly indicate the remaining AN PSDB of the PDU set.

In some other embodiments of the present application, the second information may from different wireless communication apparatuses, e.g., the source RAN node, the UE or even other apparatus. For example, the second information from the UE or source RAN node may indicate the arrival time information on the first PDU of the PDU set under Definition 1 or the arrival time information on the last PDU of the PDU set under Definition 2, or the passed AN PSDB; but not indicate the third information. The target RAN node can obtain the AN PSDB by other manners, and then calculate the remaining AN PSDB based on the second information and the AN PSDB. For example, the target RAN node can receive the arrival time information on the first PDU of the PDU set from the UE, e.g., via a PDCP control PDU, receive the AN PSDB from the source RAN node, e.g., via a handover request, and then determine the remaining AN PSDB based on the arrival time information on the first PDU of the PDU set and the AN PSDB.

Whatever, at least based on the second information, the target RAN node will determine the remaining AN PSDB, and then perform the data transmission of the PDU set in step 406. For example, the target RAN node will use the remaining AN PSDB for data transmission of remaining PDUs of the PDU set.

More detailed embodiment of the present application will be illustrated hereafter in view of different scenarios. Persons skilled in the art can well know that Definition 1 and Definition 2 are only used as examples, and the basic inventive concept of the present application can also applied to other AN PSDB definitions or interpretations (if any). For example, the technical manners on how the wireless communication apparatus obtains the first information and how the wireless communication transmits the second information to the target RAN node or others technical manners not determined by the definition of AN PSDB should also be adaptable to other scenarios with other definition of AN PSDB (if any). Persons skilled in the art should well know how to apply the illustrated solutions to other expected scenarios based on the disclosure and teaching of FIG. 4 and the following embodiments.

### Scenario I

According to some embodiments of the present application, the wireless communication apparatus, which transmits the second information, i.e., the information associated with the AN PSDB of a PDU set to the target RAN node, is a source RAN node, e.g., a source gNB. Under Definition 1, the PDU set can be a downlink PDU set or an uplink PDU set; while under Definition 2, the PDU can only be a downlink PDU set.

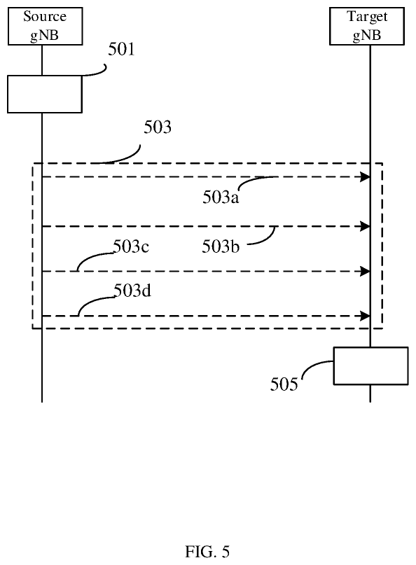

FIG. 5 is a flow chart illustrating an exemplary procedure of a method supporting delay budget handling according to some embodiments of the present applications.

Referring to FIG. 5, according to some embodiments of the present application, in step 501, the source gNB may receive the first information, i.e., the information indicating an AN PSDB of a PDU set from a CN node, e.g., an AMF, in PDU session setup request or PDU session modification request message. The AN PSDB may be per QoS flow level, i.e. the AN PSDB is applied to all PDU sets in the QOS flow. For example, the source gNB may receive the AN PSDB of the PDU set, or receive the CN PSDB and a total PSDB associated with the PDU set. In the case that the source gNB receives the CN PSDB and the total PSDB, the source gNB can calculate or determine the AN PSDB based on the CN PSDB and the total PSDB, e.g., by subtracting the CN PSDB from the total PSDB.

In response to a handover during the data transmission of the PDU, data transmission of the remaining PDUs of the PDU set will be performed by the target RAN node rather than the source RAN node, which may include all PDUs of the PDU set in some scenarios. In Scenario I, the source RAN node will transmit the second information, i.e., information associated with the AN PSDB of the PDU set to the target RAN node in step 503, so that the target RAN node, e.g., a target gNB can perform the data transmission of the PDU set at least based on the second information in step 505 to achieve more accurate QoS management and scheduling. For example, the source gNB can transmit the second information in step 503a via (or with) a signaling of handover request, or transmit the second information in step 503b via (or with) a signaling of SN status transfer, transmit the second information in step 503c via (or with) a user plane protocol carried by GTP-U extension header, e.g., of any PDU of the PDU set, or transmit the second information in step 503d via (or with) a source to target container in handover related signalling, e.g., a source next generation (NG)-RAN node to target NG-RAN node transparent container in handover related signalling.

As state above, the second information are various. More specific embodiments are illustrated in view of some exemplar second information.

According to some embodiments of the present application (hereafter, Scheme 1-1), under Definition 1, the second information may indicate the arrival time information on the first PDU of the PDU set and the third information indicating the AN PSDB. The arrival time information on the first PDU of the PDU set and the third information may be transmitted to the target gNB in the same or different messages and/or signaling. For example, the source gNB may transmit both the arrival time information on the first PDU of the PDU set and the third information in step 503a via the signaling of handover request. In another example, the source gNB may transmit the third information in step 503a via the signaling of handover request, and transmit the arrival time information on the first PDU of the PDU set in step 503b via the SN transfer message. In yet another example, the source gNB may transmit the third information in step 503a via the signaling of handover request, and transmit the arrival time information on the first PDU of the PDU set in step 503c via the user plane protocol, e.g., including the arrival time information on the first PDU of the PDU set in a GTP-U extension header of a PDU of the PDU set.

The arrival time information on the first PDU of the PDU set can be defined in various manners. For example, in the case that the PDU set is a downlink PDU set, the arrival time information on the first PDU of the PDU set may indicate at least one of the following: absolute time of the first PDU of the PDU set arriving at the source gNB from a CN node, e.g., the UPF; SFN timing that represents time of the first PDU of the PDU set arriving at the source gNB from a CN node, e.g., the UPF; or buffered time of the first PDU of the PDU set at the source gNB.

Exemplary of the absolute time of the first PDU of a PDU set arriving at the source gNB from a CN node is coordinated universal time (UTC) time of the first PDU of a downlink PDU set arriving at the source gNB. Exemplary SFN timing that represents time of the first PDU of a PDU set arriving at the source gNB from a CN node is the time difference to the initial SFN boundary (e.g., SFN=0). In the case of time non-synchronization between the source gNB and target gNB, the source gNB may send the SFN timing in the source gNB (i.e., the timing difference to the initial SFN boundary (e.g. SFN=0) of the source gNB) plus an SFN offset between the source gNB and the target gNB to the target gNB; or the source gNB may calculate the SFN timing of the target gNB (i.e., the timing difference to the initial SFN boundary (e.g. SFN=0) of the source gNB) according to the SFN offset between the source gNB and the target gNB and then send the SFN timing of the target gNB to the target gNB. Exemplary buffered time of the first PDU of a PDU set in the source gNB is how long the first PDU has been buffered in the source gNB until being sent by the source gNB. In some scenarios, the first PDU of a downlink PDU set may arrive at the source gNB during the execution of the handover or after the handover is completed. For such a PDU set, the source gNB may indicate that the buffered time of the first PDU of the PDU set at the source RAN node is zero.

In addition, regarding the special scenarios that the first PDU of a downlink PDU set may arrive at the source gNB during execution of the handover or after the handover is completed, besides the above solution, the source gNB may indicate only the third information to implicitly indicate that entire of the AN PSDB is to be used for data transmission of the PDU set, or transmit the third information and explicitly indicate that the entire of the AN PSDB is to be used for data transmission of the PDU set. For example, a bit may be used in the user plane protocol from the source gNB to the target gNB to indicate that the entire of the AN PSDB is to be used for data transmission of the PDU set. This bit can be newly added compared with a legacy user plane protocol in the GTP-U extension header.

In the case that the PDU set is an uplink PDU set, the arrival time information on the first PDU of the PDU set may indicate at least one of the following: time of receiving BSR for transmission of the first PDU of the PDU set from the UE; time of the first PDU arriving at an AS layer reported by the UE, e.g., via the PDCP header or in a MAC CE or PDCP control PDU or RRC signaling (e.g. in the RRCReconfigurationComplete or UEAssitanceInformation message); or time of the first PDU generated in an application layer reported by the UE, e.g., via the PDCP header or in a MAC CE or PDCP control PDU or RRC signaling; or buffered time of the first uplink PDU of the PDU set at the UE. Similarly, each of time of receiving BSR for transmission of the first PDU of the PDU set from the UE, time of the first PDU arriving at an AS layer reported by the UE, and time of the first PDU generated in an application layer reported by the UE can be defined in absolute time, e.g., UTC or SFN timing. For example, the time of the first PDU arriving at an AS layer reported by the UE is the absolute time reported by the UE that the first PDU arrives at the SDAP layer or PDCP layer, or is the SFN timing that represents the time reported by the UE that the first PDU arrives at the SDAP layer or PDCP layer. In another example, time of the first PDU generated in an application layer reported by the UE is the absolute time reported by the UE that the first PDU generated in the application layer at the SDAP or PDCP layer, or SFN timing reported by the UE that represents the time of the first PDU generated in the application layer at the SDAP layer or PDCP layer.

In the case that the source gNB is in a CU-DU split architecture and a DU of the source RAN node receives the arrival time information on the first PDU of a PDU set, the DU of the source gNB will transmit the arrival time information on the first PDU of the PDU set to the CU via F1-AP signaling or F1-U user plane protocol. For example, the DU may receive the time of the first PDU of an uplink PDU set arriving at an AS layer reported by the UE via the MAC header or MAC CE, abstract it from the MAC header or MAC CE, and then transmit the received time of the first PDU arriving at the AS layer to the CU via F1-AP signaling or F1-U user plane protocol.

The target gNB will calculate the passed AN PSDB of the PDU first based on the arrival time information on the first PDU of the PDU set, and then calculate the remaining AN PSDB of the PDU set based on the passed AN PSDB and the total AN PSDB determined from the third information. Regarding the calculation of the passed AN PSDB and remaining AN PSDB, it has been illustrated above, and will not be repeated herein.

According to some other embodiments of the present application (hereafter, Scheme 1-2), under Definition 2, the second information indicate the arrival time information on the last PDU of the PDU set and the third information indicating the AN PSDB. The arrival time information on the last PDU of the PDU set and the third information may be transmitted to the target gNB in the same or different messages and/or signaling. For example, the source gNB may transmit both the arrival time information on the last PDU of the PDU set and the third information in step 503a via the signaling of handover request. In another example, the source gNB may transmit the third information in step 503a via the signaling of handover request and transmit the arrival time information on the last PDU of the PDU set in step 503b via the SN transfer message. In yet another example, the source gNB may transmit the third information step 503a via the signaling of handover request and transmit the arrival time information on the last PDU of the PDU set in step 503c via the user plane protocol, e.g., including it in a GTP-U extension header of a PDU of the PDU set.

The arrival time information on the last PDU of the PDU set can be defined in various manners. However, in Scheme 1-2, the arrival time information on the last PDU of the PDU set can only be applied to downlink PDU set(s). For example, the arrival time information on the last PDU of a downlink PDU set may indicate at least one of the following: time of the last PDU of the PDU set arriving at the source gNB from a CN node, e.g., the UPF, which may be defined in absolute time or SFN timing; or buffered time of the last PDU of the PDU set at the source RAN node.

Similarly, exemplary SFN timing that represents time of the last PDU of a PDU set arriving at the source gNB from a CN node is the time difference to the initial SFN boundary (e.g., SFN=0). In the case of SFN timing and time non-synchronization between the source gNB and target gNB, the source gNB may send the SFN timing in the source gNB (i.e., the timing difference to the initial SFN boundary (e.g., SFN=0) of the source gNB) plus an SFN offset between the source gNB and target gNB to the target gNB, or the source gNB may calculate the SFN timing of the target gNB (i.e., the timing difference to the initial SFN boundary (e.g., SFN=0) of the source gNB) according to the SFN offset between the source gNB and the target gNB and then send the SFN timing of the target gNB to the target gNB. Exemplary buffered time of the first PDU of a PDU set in the source gNB is how long the first PDU has been buffered in the source gNB until being sent by the source gNB. In some scenarios, the last PDU of a downlink PDU set may arrive at the source gNB during the execution of the handover or after the handover is completed, and the source gNB may indicate that the buffered time of the last PDU of the PDU set at the source RAN node is zero.

In addition, regarding the special scenarios that the last PDU of a downlink PDU set may arrive at the source gNB during the execution of the handover or after the handover is completed, besides the above solution, the source gNB may indicate only the third information to implicitly indicate that entire of the AN PSDB is to be used for data transmission of the PDU set, or transmit the third information and explicitly indicate that the entire of the AN PSDB is to be used for data transmission of the PDU set. For example, a bit may be added in the user plane protocol from the source gNB to the target gNB to indicate that the entire of the AN PSDB is to be used for data transmission of the PDU set.

The target gNB will firstly calculate the passed AN PSDB of the PDU set based on the arrival time information on the last PDU of the PDU set arriving at the source gNB, and then calculate the remaining AN PSDB of the PDU set based on the passed AN PSDB and the total AN PSDB determined from the third information. Regarding the calculation of the passed AN PSDB and remaining AN PSDB, it has been illustrated above, and will not be repeated herein.

According to some yet other embodiments of the present application (hereafter, Scheme 1-3), the source gNB will calculate the passed AN PSDB and transmit the second information by including the third information and the passed AN PSDB. Regarding the passed AN PSDB, it can be calculated based on the arrival time information on the first PDU of the PDU set as illustrated in Scheme 1-1 or based on the arrival time information on the last PDU of the PDU set as illustrated in Scheme 1-2, and will not be repeated herein.

Similarly, the source gNB will transmit the second information as illustrated in Scheme 1-1 and Scheme 1-2, which is also omit in details. The target gNB will calculate the remaining AN PSDB of the PDU set based on the passed AN PSDB and the total AN PSDB determined from the third information as illustrated above, which will not be repeated herein.

According to some yet other embodiments of the present application (hereafter, Scheme 1-4), the source gNB will calculate the remaining AN PSDB of the PDU set and transmit the second information by including the remaining AN PSDB of the PDU set. The remaining AN PSDB is calculated based on the passed AN PSDB and the AN PSDB determined from the first information as illustrated above. Similarly, regarding the passed AN PSDB, it can be calculated based on the arrival time information on the first PDU of the PDU set as illustrated in Scheme 1-1 or based on the arrival time information on the last PDU of the PDU set as illustrated in Scheme 1-2, and will not be repeated herein. Moreover, the second information can be transmitted as illustrated in Scheme 1-1 or Scheme 1-2, and will not be repeated either.

In addition, as stated above, in some scenarios, the second information may from the source RAN node and UE respectively, e.g., the source RAN node only transmit the third information to the target RAN node to indicate the AN PSDB. The arrival time of the first PDU or arrival time of the last PDU or the passed AN PSDB etc. can be transmitted by the UE to the target RAN node. In some other scenarios, the source RAN node may transmit the arrival time of the first PDU or arrival time of the last PDU or the passed AN PSDB etc. to the target RAN node. The target node can obtain the third information from another apparatus besides the UE.

### Scenario II

According to some embodiments of the present application, the wireless communication apparatus, which transmits the second information, i.e., the information associated with the AN PSDB of a PDU set to the target RAN node is a remote apparatus, e.g., a UE. However, the PDU set can only be an uplink PDU set.

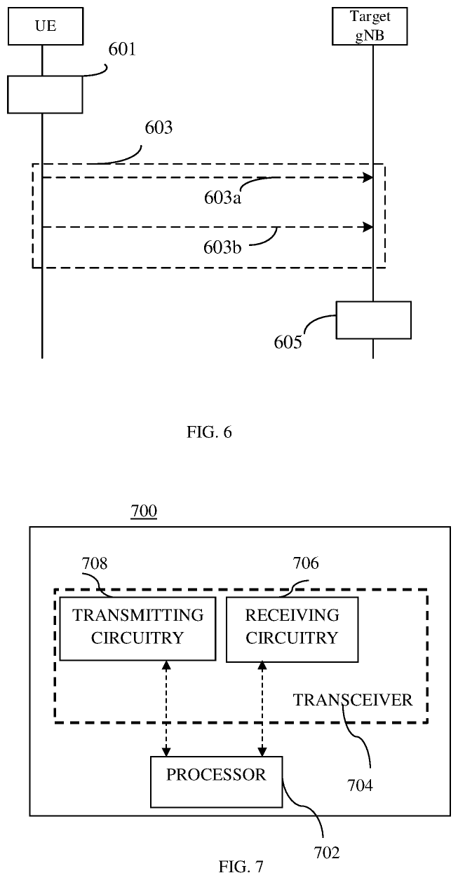

FIG. 6 is a flow chart illustrating an exemplary procedure of a method supporting delay budget handling according to some other embodiments of the present applications.

Referring to FIG. 6, according to some embodiments of the present application, in step 601, the UE may receive the first information, i.e., the information indicating an AN PSDB of a PDU set from the network side, e.g., from a source gNB or a CN node (e.g. AMF). For example, the UE may receive the AN PSDB of the PDU set or receive the CN PSDB and a total PSDB associated with the PDU set. In the case that the UE receives the CN PSDB and the total PSDB, the UE can calculate or determine the AN PSDB by subtracting the CN PSDB from the total PSDB.

In response to a handover during data transmission of the PDU set, data transmission of the remaining PDUs of the PDU set will be performed by the target RAN node rather than the source RAN node, which may include all PDUs of the PDU set in some scenarios. In Scenario II, the network side may request the UE to report the second information, i.e., information associated with the AN PSDB of the PDU set to the target in step 603 in response to success of the handover, e.g., via a PDCP header, or MAC CE or PDCP control PDU, or RRC signaling; so that the target RAN node can perform the data transmission of the PDU set at least based on the second information in step 605 to achieve more accurate QoS management and scheduling. For example, the UE can transmit the second information upon the success of the handover in step 603a, e.g., in handover command or after the handover in step 603b. An exemplary handover command is RRCRecofiguration with sync.

Similarly, more specific embodiments are illustrated in view of different second information.

According to some embodiments of the present application (hereafter, Scheme 2-1), under Definition 1, the second information may indicate the arrival time information on the first PDU of the PDU set and the third information indicating the AN PSDB. The arrival time information on the first PDU of the PDU set and the third information may be transmitted to the target gNB in the same or different messages and/or signaling in response to the success of the handover, e.g., upon the handover being completed and/or after the handover. In some scenarios, as stated above, the second information may indicate the arrival time information on the first PDU of the PDU set, while the target RAN node can obtain the third information in other manners, e.g., from the source RAN node.

The arrival time information on the first PDU of the PDU set can be defined in various manners, which is identical or similar to the arrival time information on the first PDU of an uplink PDU set as illustrated in Scheme 1-1.

For example, the arrival time information on the first PDU of the PDU set may indicate at least one of the following: absolute time of receiving BSR for transmission of the last PDU of the PDU set from the UE; absolute time of the last PDU arriving at an AS layer reported by the UE; absolute time of the last PDU generated in an application layer reported by the UE; SFN timing that represents time of receiving BSR for transmission of the last PDU of the PDU set from the UE; SFN timing that represents time of the last PDU arriving at an AS reported by the UE; SFN timing that represents the last PDU generated in an application layer reported by the UE; or buffered time of the last PDU of the PDU set at the UE. In the case that a last PDU of the PDU set arrives at the UE later than receiving a handover command, or during the execution of the handover or after the handover is completed, the second information may indicate that entire of the AN PSDB is to be used for data transmission of the PDU set, e.g., by a bit in a PDCP header, or indicate or the buffered time of the last PDU of the PDU set at the UE is zero.

Similar to Scheme 1-1, the target gNB will first calculate the passed AN PSDB of the PDU based on the arrival time information on the first PDU of the PDU set, and then calculate the remaining AN PSDB of the PDU set based on the passed AN PSDB and the total AN PSDB determined from the third information.

According to some other embodiments of the present application (hereafter, Scheme 2-2), under Definition 2, the second information may indicate the arrival time information on the last PDU of the PDU set and the third information indicating the AN PSDB. Similarly, the arrival time information on the last PDU of the PDU set and the third information may be transmitted to the target gNB in the same or different messages and/or signaling. In some scenarios, as stated above, the second information from the UE may indicate the arrival time information on the last PDU of the PDU set, while the target RAN node can obtain the third information in other manners, e.g., from the source RAN node.

The arrival time information on the last PDU of the PDU set can be defined in various manners. For example, similar to the arrival time information on the first PDU of an uplink PDU set, the arrival time information on the last PDU of the PDU set may indicate at least one of the following: absolute time of receiving BSR for transmission of the last PDU of the PDU set from the UE; absolute time of the last PDU arriving at an AS layer reported by the UE; absolute time of the last PDU generated in an application layer reported by the UE; SFN timing that represents time of receiving BSR for transmission of the last PDU of the PDU set from the UE; SFN timing that represents time of the last PDU arriving at an AS reported by the UE; SFN timing that represents the last PDU generated in an application layer reported by the UE; or buffered time of the last PDU of the PDU set at the UE. In some scenarios, the last PDU of an uplink PDU set may arrive at the UE later than receiving a handover command or during the execution of the handover or after the handover is completed, the UE may indicate that the buffered time of the last PDU of the PDU set at the source RAN node is zero.

In addition, regarding the special scenarios that the last PDU of an uplink PDU set may arrive at the UE later than receiving a handover command or during the execution of the handover or after the handover is completed, besides the above solution, the UE may indicate only the third information to implicitly indicate that entire of the AN PSDB is to be used for data transmission of the PDU set, or transmit the third information and explicitly indicate that the entire of the AN PSDB is to be used for data transmission of the PDU set. For example, a bit may be added in a PDCP header compared with a legacy one from the UE to the target gNB to indicate that the entire of the AN PSDB is to be used for data transmission of the PDU set.

Similar to Scheme 1-1, the target gNB will first calculate the passed AN PSDB of the PDU set based on the arrival time information on the last PDU of the PDU set, and then calculate the remaining AN PSDB of the PDU set based on the passed AN PSDB and the total AN PSDB determined from the third information.

According to some yet other embodiments of the present application (hereafter, Scheme 2-3), the UE will calculate the passed AN PSDB and transmit the second information by including the third information and the passed AN PSDB. Regarding the passed AN PSDB, it can be calculated based on the arrival time information on the first PDU of the PDU set as illustrated in Scheme 2-1 or based on the arrival time information on the last PDU of the PDU set as illustrated in Scheme 2-2, and will not be repeated herein. The target gNB will calculate the remaining AN PSDB of the PDU set based on the passed AN PSDB and the total AN PSDB determined from the third information. In some scenarios, the second information from the UE may indicate the passed AN PSDB, while the target RAN node can obtain the third information in other manners, e.g., from the source RAN node.

According to some yet other embodiments of the present application (hereafter, Scheme 2-4), the UE will calculate the remaining AN PSDB of the PDU set and transmit the second information by including the remaining AN PSDB of the PDU set. The remaining AN PSDB is calculated based on the passed AN PSDB and the AN PSDB determined from the first information. Similarly, regarding the passed AN PSDB, it can be calculated based on the arrival time information on the first PDU of the PDU set as illustrated in Scheme 2-1 or based on the arrival time information on the last PDU of the PDU set as illustrated in Scheme 2-2, and will be repeated herein.

Besides methods, embodiments of the present application also propose an apparatus of supporting delay budget handling. FIG. 7 is a block diagram of an apparatus of supporting delay budget handling according to some embodiments of the present application.

Referring to FIG. 7, the apparatus 700, e.g., a UE or a source RAN node, or a target RAN node may include at least one processor 702 and at least one transceiver 704. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some embodiments of the present application, when the apparatus 700 is a target RAN node, e.g., a target gNB, the processor is configured to: receive information associated with an AN PSDB of a PDU set in response to a handover of a UE from a source RAN node to the RAN node; and perform data transmission of the PDU set at least based on the information associated with the AN PSDB.

According to some other embodiments of the present application, when the apparatus 700 is a wireless communication apparatus rather than the target RAN node, e.g., a source gNB or a UE, the processor may be configured to: receive first information indicating AN PSDB of a PDU set; and transmit second information associated with the AN PSDB of the PDU set at least based on the first information indicating the AN PSDB in response to a handover of a UE that happens during data transmission of the PDU set.

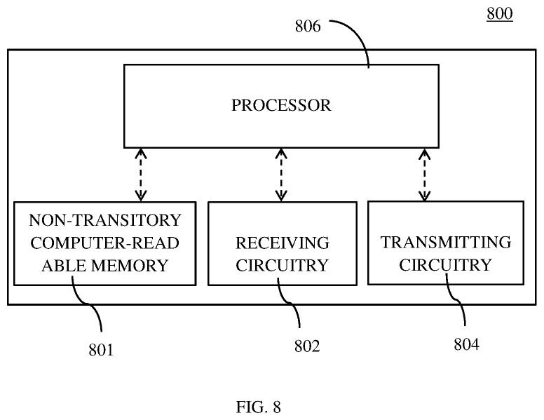

In another example, FIG. 8 illustrates a block diagram of an apparatus 800 of supporting delay budget handling according to some other embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The apparatus 800 may be a target RAN node or a UE or a source RAN node configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. The processor 806 may be a CPU, a DSP, a microprocessor etc. In certain embodiments of the present application, the apparatus 800 may further include an input device, a memory, and/or other components.

In some embodiments of the present application, the non-transitory computer-readable medium 801 may have stored thereon computer-executable instructions to cause the processor 806 to implement the method with respect to the target RAN node, e.g., a target gNB as described above. For example, the computer-executable instructions, when executed, cause the processor 806 interacting with receiving circuitry 802 and transmitting circuitry 804, so as to perform the steps with respect to a target RAN node as depicted above.

In some other embodiments of the present application, the non-transitory computer-readable medium 801 may have stored thereon computer-executable instructions to cause a processor to implement the method with respect to a source RAN node or a UE as described above. For example, the computer-executable instructions, when executed, cause the processor 806 interacting with receiving circuitry 802 and transmitting circuitry 804, so as to perform the steps with respect to a source RAN node or a UE as depicted above.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A radio access network (RAN) node, comprising:
at least one memory; and
at least one processor coupled with the at least one memory and configured to cause the RAN node to:
receive information associated with an access network (AN) protocol data unit (PDU) set delay budget (PSDB) (AN PSDB) of a PDU set in response to a handover of a user equipment (UE) from a source RAN node to the RAN node; and
perform data transmission of the PDU set based at least in part on the information associated with the AN PSDB.

2. The RAN node of claim 1, wherein one of:
the AN PSDB is a difference between a first time of a first PDU of a downlink PDU set received at the RAN node and a second time of a last PDU or all PDUs of the downlink PDU set successfully delivered to the UE; or
the AN PSDB is the difference between a first time of a first PDU of an uplink PDU set processed at the UE and a second time of a last PDU or all PDUs of the uplink PDU set successfully transmitted from the UE.

3. The RAN node of claim 2, wherein the information associated with the AN PSDB indicates arrival time information on the first PDU of the PDU set and AN PSDB information indicating the AN PSDB, and the processor is configured to cause the RAN node to:
calculate a remaining part of the AN PSDB based on the arrival time information on the first PDU of the PDU set and the AN PSDB information; and
use the remaining part of the AN PSDB for data transmission of remaining PDUs of the PDU set.

4. The RAN node of claim 1, wherein the information associated with the AN PSDB indicates the AN PSDB and a passed part of the AN PSDB, and the processor is configured to cause the RAN node to:
calculate a remaining part of the AN PSDB based at least in part on the AN PSDB information and the passed part of the AN PSDB; and
use the remaining part of the AN PSDB for data transmission of remaining PDUs of the PDU set.

5. The RAN node of claim 1, wherein the information associated with the AN PSDB indicates a remaining part of the AN PSDB of the PDU set, and the processor is configured to cause the RAN node to:
use the remaining part of the AN PSDB for data transmission of remaining PDUs of the PDU set.

6. The RAN node of claim 1, wherein the information associated with the AN PSDB is received from the source RAN node during the handover via at least one of:
a signaling of a handover request;
a signaling of a sequence number (SN) status transfer;
a user plane protocol carried by general packet radio service (GPRS) tunnel protocol for a user plane (GTP-U) extension header; or
a source to target transparent container within handover related signaling.

7. The RAN node of claim 1, wherein the information associated with the AN PSDB is received from the UE in response to success of the handover via at least one of a packet data convergence protocol (PDCP) header, a media access control (MAC) control element (CE) or PDCP control PDU, or radio resource control (RRC) signaling.

8. A wireless communication apparatus, comprising:
at least one memory; and
at least one processor coupled with the at least one memory and configured to cause the wireless communication apparatus to:
receive first information indicating an access network (AN) protocol data unit (PDU) set delay budget (PSDB) (AN PSDB) of a PDU set; and
transmit second information associated with the AN PSDB of the PDU set least based at least in part on the first information indicating the AN PSDB in response to a handover of a user equipment (UE) that happens during data transmission of the PDU set.

9. The wireless communication apparatus of claim 8, wherein one of:
the AN PSDB is a difference between a first time of a first PDU of a downlink PDU set received at a radio access network (RAN) node and a second time of a last PDU or all PDUs of the downlink PDU set successfully delivered to the UE; or
the AN PSDB is the difference between a first time of a first PDU of an uplink PDU set processed at the UE and a second time of a last PDU or all PDUs of the uplink PDU set successfully transmitted from the UE.

10. The wireless communication apparatus of claim 9, wherein the second information associated with the AN PSDB indicates arrival time information on the first PDU of the PDU set and third information indicating the AN PSDB.

11. The wireless communication apparatus of claim 9, wherein the second information associated with the AN PSDB indicates the AN PSDB and a passed part of the AN PSDB, and the processor is configured to cause the wireless communication apparatus to:
calculate the passed part of the AN PSDB based at least in part on arrival time information on the first PDU of the PDU set.

12. The wireless communication apparatus of claim 9, wherein, the second information associated with the AN PSDB indicates a remaining part of the AN PSDB of the PDU set, and the processor is configured to cause the wireless communication apparatus to:
calculate a passed part of the AN PSDB based at least in part on arrival time information on the first PDU of the PDU set; and
calculate the remaining part of the AN PSDB based at least in part on the passed part of the AN PSDB and the first information indicating the AN PSDB.

13. The wireless communication apparatus of claim 8, wherein the wireless communication apparatus is a source radio access network (RAN) node of the UE, and the second information associated with the AN PSDB is transmitted during the handover via at least one of:
a signaling of a handover request;
a signaling of a sequence number (SN) status transfer;
a user plane protocol carried by general packet radio service (GPRS) tunnel protocol for a user plane (GTP-U) extension header; or
a source to target transparent container within handover related signaling.

14. A method performed by a radio access network (RAN) node, the method comprising:
receiving information associated with an access network (AN) protocol data unit (PDU) set delay budget (PSDB) (AN PSDB) of a PDU set in response to a handover of a user equipment (UE) from a source RAN node to the RAN node; and
performing data transmission of the PDU set based at least in part on the information associated with the AN PSDB.

15. (canceled)

16. A processor for wireless communication, comprising:
at least one controller coupled with at least one memory and configured to cause the processor to:
receive information associated with an access network (AN) protocol data unit (PDU) set delay budget (PSDB) (AN PSDB) of a PDU set in response to a handover of a user equipment (UE) from a source radio access network (RAN) node to a RAN node; and
perform data transmission of the PDU set based at least in part on the information associated with the AN PSDB.

17. The processor of claim 16, wherein one of:
the AN PSDB is a difference between a first time of a first PDU of a downlink PDU set received at the RAN node and a second time of a last PDU or all PDUs of the downlink PDU set successfully delivered to the UE; or
the AN PSDB is the difference between a first time of a first PDU of an uplink PDU set processed at the UE and a second time of a last PDU or all PDUs of the uplink PDU set successfully transmitted from the UE.

18. The processor of claim 17, wherein the information associated with the AN PSDB indicates arrival time information on the first PDU of the PDU set and AN PSDB information indicating the AN PSDB, and the controller is configured to cause the processor to:
calculate a remaining part of the AN PSDB based on the arrival time information on the first PDU of the PDU set and the AN PSDB information; and
use a remaining part of the AN PSDB for data transmission of remaining PDUs of the PDU set.

19. The processor of claim 16, wherein the information associated with the AN PSDB indicates the AN PSDB and a passed part of the AN PSDB, and the controller is configured to cause the processor to:
calculate a remaining part of the AN PSDB based at least in part on the AN PSDB information and the passed part of the AN PSDB; and
use the remaining part of the AN PSDB for data transmission of remaining PDUs of the PDU set.

20. The processor of claim 16, wherein the information associated with the AN PSDB indicates a remaining part of the AN PSDB of the PDU set, and the controller is configured to cause the processor to:
use the remaining part of the AN PSDB for data transmission of remaining PDUs of the PDU set.

21. The processor of claim 16, wherein the information associated with the AN PSDB is received from the source RAN node during the handover via at least one of:
a signaling of a handover request;
a signaling of a sequence number (SN) status transfer;
a user plane protocol carried by general packet radio service (GPRS) tunnel protocol for a user plane (GTP-U) extension header; or
a source to target transparent container within handover related signaling.
